(19) United States
(12) Patent Application Publication
(10) Pub. No.: US 2025/0384491 A1
(43) Pub. Date: Dec. 18, 2025

(54) METHODS AND SYSTEMS FOR FINANCIAL SIMULATIONS USING A MACHINE LEARNING MODEL

(71) Applicant: Credit Sesame, Inc., Mountain View, CA (US)

(72) Inventors: Adrian Nazari, Los Altos, CA (US); Pejman Makhfi, Los Gatos, CA (US); Rohan Kadakia, Palo Alto, CA (US); Deepak Sanem, Fremont, CA (US); Feng Zhao, El Paso, TX (US); Isaac Golberg, Thousand Oaks, CA (US); Mark Jarrell, Mountain View, CA (US)

(21) Appl. No.: 18/747,428

(22) Filed: Jun. 18, 2024

(51) Int. Cl. G06Q 40/06

(52) U.S. Cl. CPC G06Q 40/06

(57) ABSTRACT

Using various embodiments, systems, methods, and techniques are disclosed to perform financial simulations using a machine learning model are disclosed. In one embodiment, a system receives credit data of a user and a request to perform a financial simulation of a financial profile pertaining to a consumer. The credit data is aggregated to determine one or more features required by an AI/ML model, and then submits the aggregated data to the model. The system then returns a prediction based on the financial simulation provided by the ML model.

### FIELD OF THE INVENTION

Embodiments of the present invention relate generally to using Artificial Intelligence (AI) and/or Machine Learning (ML) models to perform desired tasks. More particularly, embodiments of the invention relate to utilizing AI/ML models that can assist in financial simulations.

### BACKGROUND OF THE INVENTION

A consumer's credit profile may be simulated for different reasons. One reason includes testing how different factors, such as income, expenses, credit history, and credit score, affect the consumer's ability to access credit products and services. For example, a lender might want to see how a consumer's credit profile changes after applying for a loan or a mortgage.

Another possible reason is to help the consumer understand their own credit profile and improve it over time. For example, a consumer might want to see how their credit score is calculated and what factors influence it. They might also want to learn how to improve their credit score by paying their bills on time, reducing their debt, and checking their credit reports regularly.

A consumer's credit profile can be simulated by using tools that can estimate how different actions, such as applying for a loan, paying off a balance, or changing the credit limit, might affect the consumer's credit score. As known to a person having ordinary skill in the art, a credit score is a numerical representation of the consumer's creditworthiness, based on various factors, such as payment history, credit utilization, length of credit history, types of credit, and new credit inquiries.

While conventional tools simulate a consumer's credit profile by use of predefined rules and algorithms to simulate a consumer's credit profile based on their personal information and financial data, they lack the ability to learn from historical data and predict patterns/future outcomes based on current inputs.

Therefore, methods, systems, and techniques are required to reliably simulate a consumer's credit profile.

### SUMMARY OF THE DESCRIPTION

Using various embodiments, systems, methods, and techniques are disclosed to perform financial simulations using a machine learning model are disclosed. In one embodiment, a system implementing the techniques described herein receives a request to perform at least one financial simulation of a financial profile pertaining to a consumer. The request can include metadata that is required to perform the requested financial simulations. The system then receives credit data of the consumer. The credit data can include the credit score, tradeline, credit inquiry, or public record of the consumer. The system then aggregates the credit data of the consumer to determine one or more features required by an AI/ML model and submits the aggregated data to the model. In one embodiment, the ML model was previously trained using credit profiles of a plurality of consumers. Thereafter, the system returns a prediction based on the financial simulation provided by the ML model.

The financial simulation can include determining an impact of an action. The action can comprise being denied for a credit product while sustaining a hard credit inquiry, getting a new credit card, getting a new personal loan, making a change in credit card balance or utilization, resolving a negative mark such as a collection, or taking on a new delinquency.

In one embodiment, the prediction generated by the system determines both a direction and a magnitude of the user's credit score change under the at least one action. In one embodiment, aggregating the credit data includes creating a feature array that is submitted to the ML model. The prediction includes a trajectory of a financial condition of the user over a predetermined time period (e.g., six months). The predetermined time period can be calculated by a difference between a first credit data pull date and a second credit data pull date related to the user's profile.

### BRIEF DESCRIPTION OF THE DRAWINGS

The present invention is illustrated by way of example and not limitation in the figures of the accompanying drawings in which like references indicate similar elements.

FIG. 1 illustrates a block diagram illustrating the general components for performing a financial simulation using a trained AI/ML model, in accordance with one embodiment of the invention.

FIG. 2 illustrates a flow chart describing the process of generating results relating to financial simulations performed by a trained AI/ML model, in accordance to one embodiment of the present invention.

FIG. 3 illustrates an exemplary process of performing a financial simulation, in accordance to one embodiment of the present invention.

FIG. 4 illustrates another exemplary process of performing a financial simulation, in accordance to one embodiment of the present invention.

FIG. 5 illustrates yet another exemplary process of performing a financial simulation, in accordance to one embodiment of the present invention.

FIG. 6 is a block diagram illustrating a data processing system such as a computing system which may be used with one embodiment of the present invention.

### DETAILED DESCRIPTION

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” or “another embodiment” means that a particular feature, structure, or characteristic described in conjunction with the embodiment can be included in at least one embodiment of the invention. The appearances of the phrase “in one embodiment” in various places in the specification do not necessarily all refer to the same embodiment. The processes depicted in the figures that follow are performed by processing logic that comprises hardware (e.g., circuitry, dedicated logic, etc.), software, or a combination of both. Although the processes are described below in terms of some sequential operations, it should be appreciated that some of the operations described can be performed in a different order. Moreover, some operations can be performed in parallel rather than sequentially.

To assist in clarity of the invention “features” and “actions” as it relates to a consumer's credit profile are described herein. However, these should not be construed to be limiting the scope of the invention in any form or manner. In the event an ambiguity occurs as to the usage of any particular term, it should be construed broadly within the context provided herein.

Features, as described herein, refer to a distinct and quantifiable property of an observed event. Features are independent variables that can be numerical or structural and assist in effective pattern recognition, classification, and regression. In the context of credit profiles, features are the specific details from a person's credit history that can help predict their future behavior.

As a non-limiting example, a consumer's credit profile features can be their credit score, number of open credit card accounts, their total credit card utilization, total number of negative marks (e.g., delinquencies, foreclosures, collections, and/or bankruptcies) on their profile, number of days since the consumer opened their newest credit card account, total a balance on the consumer's loans, the loans including personal loans, auto-loans or mortgages of the consumer.

Actions, as described herein, refer to changes in a person's credit behavior. Broadly, an action is any deed, operation, activity, performance or undertaking that can affect a person's financial profile, credit score, or credit history. By studying these actions, a machine learning model, as described herein, can learn to predict how future actions might affect the consumer's credit profile/credit score. This can be useful for people who want to improve their credit score and need to know which actions will have the most impact.

As a non-limiting example, the actions that can be applied on a consumer's credit profile can include applying for a credit product, applying for a new personal loan, increasing or decreasing credit card balance, increasing or decreasing total credit utilization, resolving a negative mark on the financial profile, taking on a new delinquency, or a combination thereof. Actions can be performed or undertaken by the consumer or a third-party (e.g., lender).

As described herein, a prior credit profile signifies the consumer's financial profile before one or more actions were undertaken, and a posterior credit profile signifies the consumer's financial profile after the action(s) were undertaken.

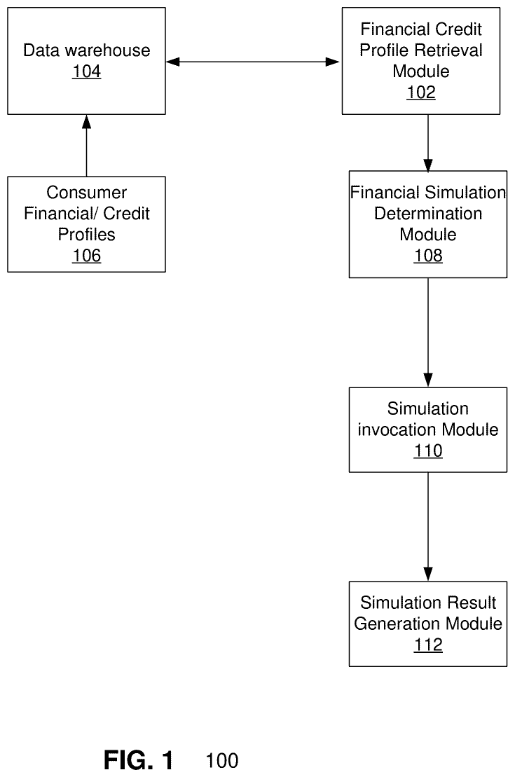

FIG. 1 is a block diagram 100 illustrating the general components for performing a financial simulation using a trained AI/ML model, in accordance with one embodiment of the invention. As illustrated, 102 represents retrieving the financial credit profiles retrieval module of a processing system comprising one or more computers. Module 102 can interact with a data warehouse 104 to request data using various methods. In one embodiment, this interaction is made through an Application Programming Interface (API) or a Software Development Kit (SDK). An API provides a set of rules and protocols for software applications to interact with each other. In this context, in one embodiment, computer 102 sends a request to an API of data warehouse 104, which processes the request and returns the requested data. In one embodiment, the requested can be a set of consumer financial or credit profiles 106.

An SDK is a collection of software tools and libraries that developers use to create applications for specific platforms. Therefore, in one embodiment, an SDK for data warehouse 104 can include APIs and other tools needed for computer system 102 to interact with data warehouse 104.

In yet another embodiment, financial profiles 106 can also be retrieved through Structured Query Language (SQL) queries. Computer 102 can transmit SQL commands to data warehouse 104 to retrieve profiles 106. In one embodiment, data warehouse 104 can provide web-based interfaces or GUI (Graphical User Interface) tools that allows computer 102 to interact with data warehouse 104 to retrieve profiles 106.

Moreover, in one embodiment, JSON (JavaScript Object Notation) and/or XML (extensible Markup Language) can be used by computer 102 to request profiles 106 from data warehouse 104. In this embodiment, JSON/XML can be used to structure the data request sent to data warehouse 104. Data warehouse 104 can process the request and return the requested consumer profiles 106 in the same format (JSON or XML) as originally requested by computer 102. In one embodiment, when requesting profiles 106, requests through JSON/XML are transmitted with RESTful APIs. In general, any technique known to a person having ordinary skill in the art can be used to retrieve profiles 106.

Block 108 represents the financial simulation determination module. This module determines the necessary or eligible financial simulations for each consumer based on their financial profile 106, such that it is relevant to the consumer's financial goal and benefits or improves the consumer's financial profile 106. In another embodiment, all financial simulations for which the user/consumer is eligible are requested and no initial determination is made regarding the benefit of each individual simulation on the consumer's credit profile. Financial simulation determination module packages the requested simulations, as well as the required parameters to perform those simulations.

Block 110 represents the simulation invocation module. This module interacts with financial simulation determination module 108 and transmits the requests to a trained AI/ML model. In one embodiment, the trained AI/ML model can be implemented using any of the methods, processes, or techniques disclosed in U.S. Patent Application No. ______ filed concurrently with the instant application. As a result, the above-identified disclosure is incorporated herein by reference in its entirety. Simulation invocation module 110 then receives the simulation results and transmits it to the simulation result generation module, represented by block 112.

The simulation result generation module 112 retrieves all the results and evaluates the simulations results to determine those that are most beneficial to the consumer's credit/financial profile. This module determines the simulations that are determined to potentially assist the consumer with respect to improving their credit score or financial profile and presents those results to the user requesting the simulation.

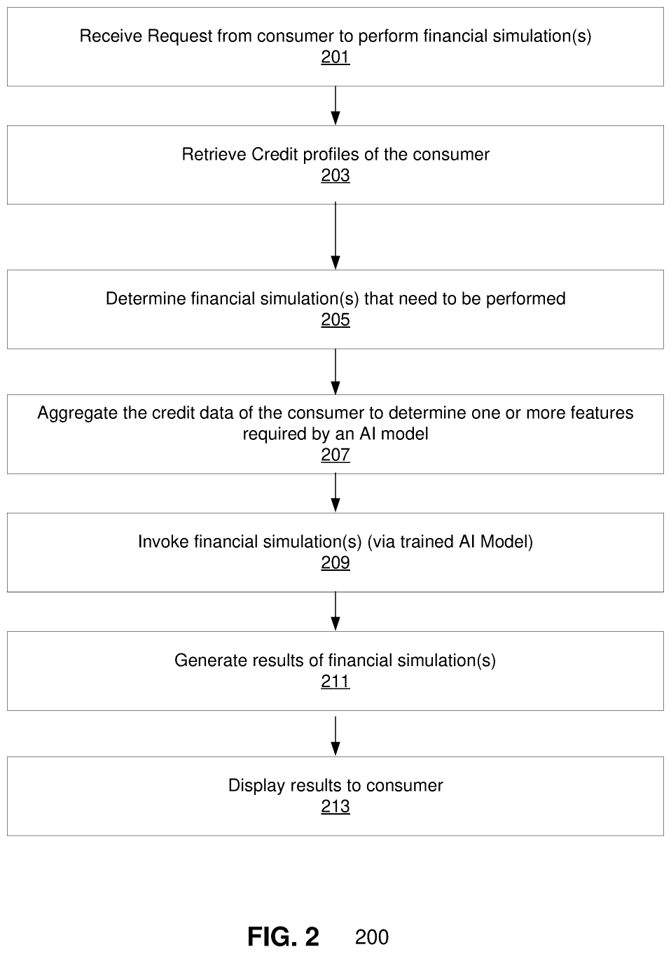

FIG. 2 illustrates a flow chart 200 describing the process of generating results pertaining to financial simulations performed by AI, in accordance to one embodiment of the present invention. As illustrated, at 201, a system performing the methods, processes, and techniques described herein, receives a request from a consumer/user to perform at least one financial simulation. In one embodiment, the present invention can be implemented in the context of an electronic commerce system in which consumers can access a website for performing a simulation on their credit/financial profiles using the techniques described herein. A server can host a website portal that interacts with a system performing the techniques described herein.

In one embodiment, the request transmitted by the consumer includes metadata that is required to perform the at least one financial simulation. The financial simulation requested can include determining an impact of at least one action comprising: being denied for a credit product while sustaining a hard credit inquiry, getting a new credit card, getting a new personal loan, making a change in credit card balance or utilization, resolving a negative mark such as a collection, or taking on a new delinquency.

At 203, the credit/financial profile of the consumer is retrieved. The credit/financial profile can include one or more credit attributes of the consumer (e.g., the consumer's Vantage3® credit score, their total current credit limit amount (aggregated over open credit card accounts), their total current credit card balance, and the number of recent (hard) inquiries run against their credit profile, etc.).

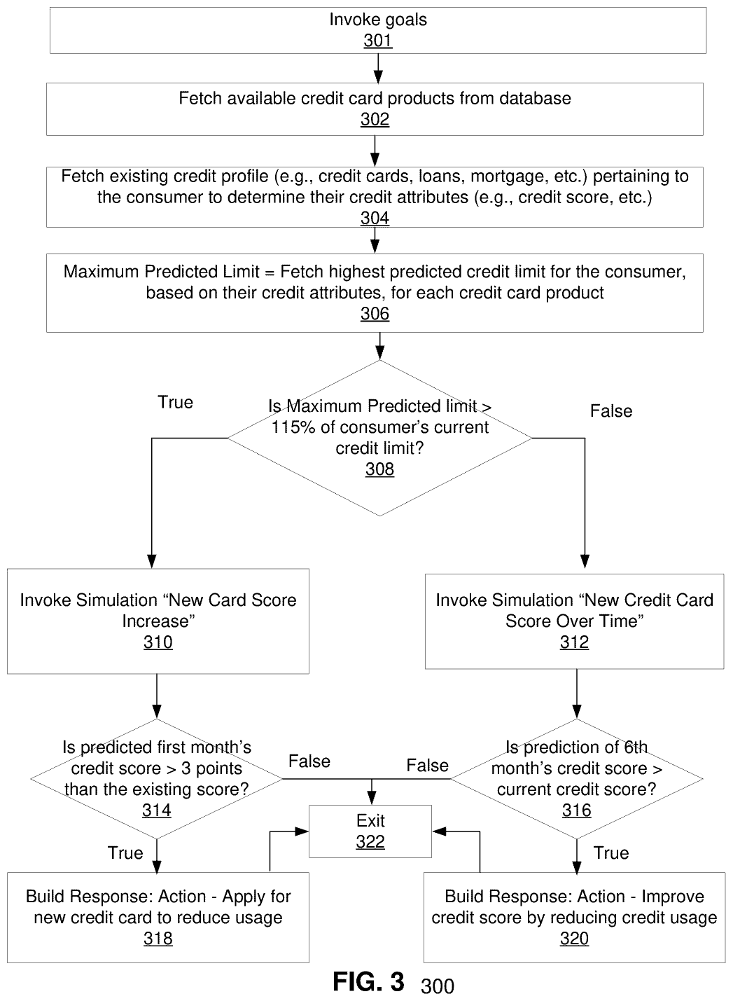

At 205, the financial simulations that need to be performed are determined. As described above, in one embodiment, every financial simulation available to the system is performed. In other words, it is determined that every known financial simulation should be performed. In another embodiment, only a set of simulations are performed where the set is determined based on the consumer's financial goal, which, in one embedment, can be determined from their credit attributes as further described in FIG. 3.

At 207, the consumer's credit data is aggregated to determine the features required by the AI/ML model to perform the requested financial simulations. In one embodiment, the aggregating includes creating a feature array that is submitted to the ML model.

At 209, the aggregated data is submitted to the ML model to invoke the financial simulations. In one embodiment, the AI/ML model is previously trained using credit profiles includes credit data of a plurality of consumers.

At 211, the results of the simulations/predictions based on the performed financial simulations are generated. In one embodiment, the simulation/prediction can include both a direction and a magnitude of the user's credit score change under the action(s). The prediction can further include a trajectory of a financial condition of the user over a predetermined time period (e.g., 1, 2, 3, 4, 5, 6 . . . n months), that is, determine the change in a consumer's financial condition over time. ‘N’ is presumed to be any real number, signifying the number of months.

At 213, in one embodiment, the results of the simulations performed are returned to the consumer.

FIG. 3 illustrates an exemplary flowchart 300 of performing financial a simulation, in accordance to one embodiment of the present invention. In one embodiment, at 301, a ‘goals’ API is invoked to get a list of goals that the consumer is eligible for, based on their credit profiles. For example, two goals for which simulations can be invoked are: apply for a new credit card to reduce a consumer's credit usage (‘new card score increase’) and help improve the consumer's credit score by reducing their credit usage (‘new credit card score over time’). A person having ordinary skill in the art would appreciate that at any given time, a consumer may only be eligible for either of these goals or none of the goals, but would never be eligible for both goals at the same time.

As illustrated, in order to determine which goal a user qualifies for, at 302, the available credit cards from the catalog are fetched. At 304, the consumer's existing credit profile is fetched. At 306, the consumer's maximum predicted credit limit is determined. In one embodiment, this can be performed by sorting all credit card products, from the product database, in descending order of each product's predicted limit based on the consumer's credit score. Thereafter, the card with highest predicted credit limit is assigned as the maximum predicted limit.

In one embodiment, the predicted credit limit can be determined for credit card products being offered. These predicted limit amounts can be generated by AI/ML regression models, one model per credit card product.

The models can be refreshed periodically, and are maintained independently. These models can, in one embodiment, take into account several credit attributes, such as: Vantage3® credit score, the user's total current credit limit amount (aggregated over open credit card accounts), their total current credit card balance, and the number of recent (hard) inquiries run against their credit profile. The predicted amounts are then provided into a system implementing the techniques described herein, when simulating the score impact of acquiring a new credit card.

Thereafter, it can be determined whether the maximum predicted credit limit is at least a predetermined percentage higher than the user's current credit limit. As an example, as illustrated, at 308, this predetermined percentage can be 115% higher than the user's current credit limit. However, a person having ordinary skill in the art would appreciate that this predetermined percentage comparison can be higher or lower by any number as needed.

In one embodiment, if the comparison, at 308, is determined to be false, the system is instructed to, at 312, invoke the simulation related to the ‘new credit card score over time’ goal, otherwise, if it is true, the system is instructed to, at 314, invoke the simulation related to the ‘new card score increase’ goal.

In one embodiment, the simulation for the ‘new card score increase’ goal includes invoking the score simulation over a predetermined number of months (e.g., 1 month, 2 months, 3 months, etc.) to determine whether the simulation results in the consumer's credit score to increase by a predetermined number of points. As illustrated, at 314, as a non-limiting example, in one embodiment, the predetermined number of months is 1 month, and the determination is whether the consumer's credit score has increased by 3 points. If true, at 318, a response is generated for the user with a guidance action that the user may apply for a new credit card to reduce their credit usage before existing at 322. If false, flow is terminated and control is passed to exit 322.

Similarly, the simulation for the ‘new credit card score over time’ goal includes invoking the score simulation over a predetermined number of months (e.g., 1 month, 2 months, 3 months . . . n months, etc.) to determine whether the simulation results in the consumer's credit score to increase by a predetermined number of points. As illustrated, at 316, in one embodiment, the predetermined number of months is the 6-th month predicted credit score and the comparison involves whether this simulated prediction is more than the consumer's current credit score. If so, at 320, a response is generated for the user with a guidance action that the user may improve their credit score by reducing their existing credit usage before existing at 322. If false, flow is terminated and control is passed to exit 322.

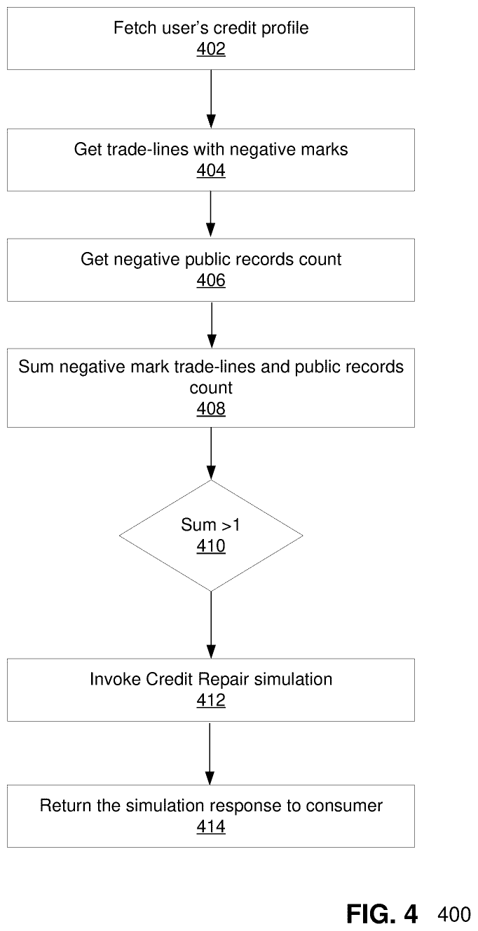

FIG. 4 illustrates another exemplary flowchart 400 of performing a financial simulation, in accordance to one embodiment of the present invention. As illustrated, at 402, the user's/consumer's credit profile is retrieved. At 404, their trade-lines with negative marks or flags are retrieved. At 406, the negative public record count is retrieved. At 408, a summation of the negative marks trade-lines and public records count is performed. At 410, if the summation is more than 1, in other words, if there are negative markings or public records, then at 412, a credit repair simulation is invoked. At 414, the results are returned to the consumer.

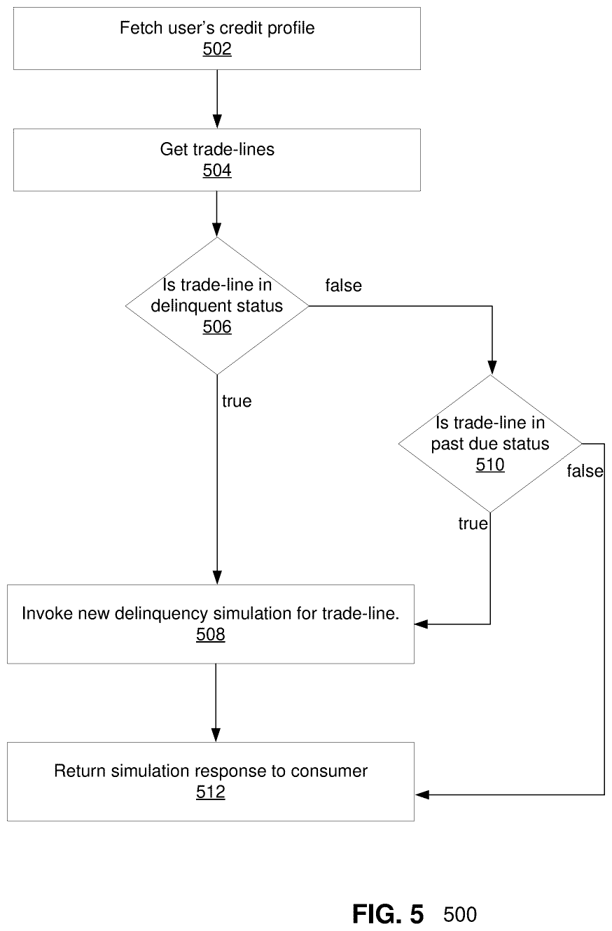

FIG. 5 illustrates yet another exemplary flowchart 500 of performing a financial simulation, in accordance to one embodiment of the present invention. At 502, the user/consumer's credit profile is fetched. At 504 the trade-lines are retrieved. At 506, if the consumer's trade-lines are determined in delinquent status, at 508, the new delinquency simulation for trade-lines is invoked. Thereafter, at 512, the simulation response is returned to the consumer. If however, the consumer's trade-lines are currently not in delinquent status, at 506, control passes to 510 where it is determined whether the trade-lines are in past due status. If the user's trade-lines are in past due status, then control is passed over to 508 again to invoke the new delinquency simulation. If the trade-lines are not in past due status, no simulation is performed and control is passed on to the user.

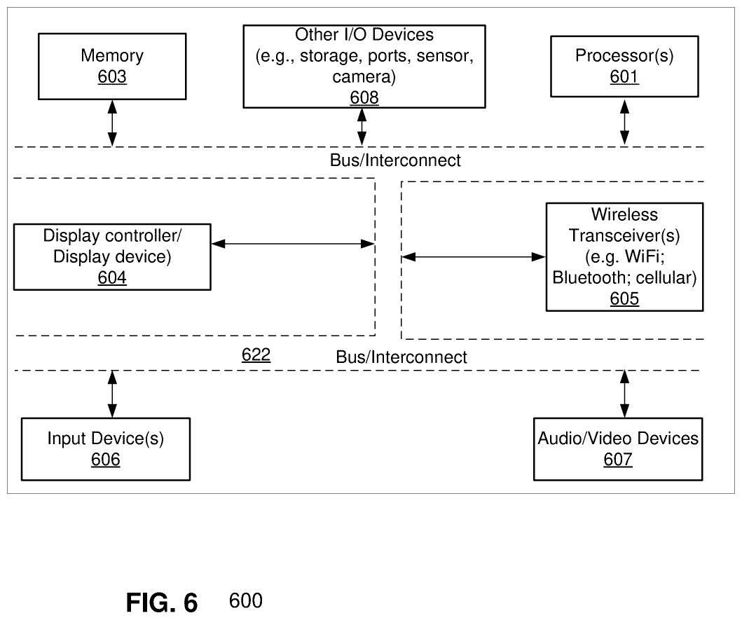

FIG. 6 is a block diagram 600 illustrating a data processing system such as a computing system 600 which may be used with one embodiment of the present invention. For example, system 600 can be implemented as part of any aspect of the current invention (e.g., transaction transfer algorithm). It should be apparent from this description that aspects of the present invention can be embodied, at least in part, in software. That is, the techniques may be carried out in a computer system or other computer system in response to its processor, such as a microprocessor, executing sequences of instructions contained in memory, such as a ROM, DRAM, mass storage, or a remote storage device. In various embodiments, hardware circuitry may be used in combination with software instructions to implement the present invention. Thus, the techniques are not limited to any specific combination of hardware circuitry and software nor to any particular source for the instructions executed by the computer system. In addition, throughout this description, various functions and operations are described as being performed by or caused by software code to simplify description. However, those skilled in the art will recognize what is meant by such expressions is that the functions result from execution of the code by a processor.

In one embodiment, system 600 can represent a computing system implementing the techniques described herein. System 600 can have a distributed architecture having a plurality of nodes coupled through a network, or all of its components may be integrated into a single unit. Computing system 600 can represent any of the data processing systems described above performing any of the processes or methods described above. In one embodiment, computer system 600 can be implemented as integrated circuits (ICs), discrete electronic devices, modules adapted to a circuit board such as a motherboard, an add-in card of the computer system, and/or as components that can be incorporated within a chassis/case of any computing device. System 600 is intended to show a high level view of many components of any data processing unit or computer system. However, it is to be understood that additional or fewer components may be present in certain implementations and furthermore, different arrangement of the components shown may occur in other implementations. System 600 can represent a desktop, a laptop, a tablet, a server, a mobile phone, a programmable logic controller, a personal digital assistant (PDA), a personal communicator, a network router or hub, a wireless access point (AP) or repeater, a set-top box, or a combination thereof.

In one embodiment, system 600 includes processor 601, memory 603, and devices 605-608 via a bus or an interconnect 622. Processor 601 can represent a single processor or multiple processors with a single processor core or multiple processor cores included therein. Processor 601 can represent one or more general-purpose processors such as a microprocessor, a central processing unit (CPU), Micro Controller Unit (MCU), etc. Processor 601 can be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 601 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions. Processor 601, can also be a low power multi-core processor socket such as an ultra low voltage processor, may act as a main processing unit and central hub for communication with the various components of the system. Such processor can be implemented as a system on chip (SoC).

Processor 601 is configured to execute instructions for performing the operations and methods described herein. System 600 further includes a graphics interface that communicates with graphics subsystem 604, which may include a display controller and/or a display device. Processor 601 can communicate with memory 603, which in an embodiment can be implemented via multiple memory devices to provide for a given amount of system memory. In various implementations the individual memory devices can be of different package types such as single die package (SDP), dual die package (DDP) or quad die package (QDP). These devices can in some embodiments be directly soldered onto a motherboard to provide a lower profile solution, while in other embodiments the devices can be configured as one or more memory modules that in turn can couple to the motherboard by a given connector. Memory 603 can be a machine readable non-transitory storage medium such as one or more volatile storage (or memory) devices such as random access memory (RAM), dynamic RAM (DRAM), synchronous DRAM (SDRAM), static RAM (SRAM), or other types of storage devices such as hard drives and flash memory. Memory 603 may store information including sequences of executable program instructions that are executed by processor 601, or any other device. System 600 can further include IO devices such as devices 605-608, including wireless transceiver(s) 605, input device(s) 606, audio IO device(s) 607, and other IO devices 608.

Wireless transceiver 605 can be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, network interfaces (e.g., Ethernet interfaces) or a combination thereof. Input device(s) 606 can include a mouse, a touch pad, a touch sensitive screen (which may be integrated with display device 604), a pointer device such as a stylus, and/or a keyboard (e.g., physical keyboard or a virtual keyboard displayed as part of a touch sensitive screen). Other optional devices 608 can include a storage device (e.g., a hard drive, a flash memory device), universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. Optional devices 608 can further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors can be coupled to interconnect 622 via a sensor hub (not shown), while other devices such as a keyboard or thermal sensor may be controlled by an embedded controller (not shown), dependent upon the specific configuration or design of system 600.

To provide for persistent storage of information such as data, applications, one or more operating systems and so forth, in one embodiment, a mass storage (not shown) may also couple to processor 601. In various embodiments, to enable a thinner and lighter system design as well as to improve system responsiveness, this mass storage may be implemented via a solid state device (SSD). However in other embodiments, the mass storage may primarily be implemented using a hard disk drive (HDD) with a smaller amount of SSD storage to act as a SSD cache to enable non-volatile storage of context state and other such information during power down events so that a fast power up can occur on RE-initiation of system activities. Also a flash device may be coupled to processor 601, e.g., via a serial peripheral interface (SPI). This flash device may provide for non-volatile storage of system software, including a basic input/output software (BIOS) as well as other firmware of the system.

Note that while system 600 is illustrated with various components of a data processing system, it is not intended to represent any particular architecture or manner of interconnecting the components; as such details are not germane to embodiments of the present invention. It will also be appreciated that network computers, handheld computers, mobile phones, and other data processing systems which have fewer components or perhaps more components may also be used with embodiments of the invention.

Thus, methods, apparatuses, and computer readable medium to implement the techniques as described herein. Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

1. A method comprising:
receiving, by a computer, a request to perform at least one financial simulation of a financial profile pertaining to a consumer, wherein the request includes metadata that is required to perform the at least one financial simulation;
receiving a credit data of the consumer, wherein the credit data includes at least one of a credit score, tradeline, credit inquiry, or a public record of the consumer;
aggregating the credit data of the consumer to determine one or more features required by the ML model;
submitting the aggregated data to a Machine Learning (ML) model, wherein the ML model was trained using credit profiles of a plurality of consumers; and
generating a prediction related to the at least one financial simulation.

2. The method of claim 1, wherein the at least one financial simulation includes determining an impact of at least one action comprising: being denied for a credit product while sustaining a hard credit inquiry, getting a new credit card, getting a new personal loan, making a change in credit card balance or utilization, resolving a negative mark such as a collection, or taking on a new delinquency.

3. The method of claim 1, wherein the prediction determines both a direction and a magnitude of the user's credit score change under the at least one action.

4. The method of claim 1, wherein the aggregating includes creating a feature array that is submitted to the ML model.

5. The method of claim 1, wherein the prediction includes a trajectory of a financial condition of the user over a predetermined time period.

6. The method of claim 5, wherein the predetermined time period is six months.

7. The method of claim 5, wherein the predetermined time period is calculated by a difference between a first credit data pull date and a second credit data pull date of the user.

8. A non-transitory computer readable medium comprising instructions, which when executed by a processing device, executes a method comprising:
receiving a request to perform at least one financial simulation of a financial profile pertaining to a consumer, wherein the request includes metadata that is required to perform the at least one financial simulation;
receiving a credit data of the consumer, wherein the credit data includes at least one of a credit score, tradeline, credit inquiry, or a public record of the consumer;
aggregating the credit data of the consumer to determine one or more features required by the ML model;
submitting the aggregated data to a Machine Learning (ML) model, wherein the ML model was trained using credit profiles of a plurality of consumers; and
generating a prediction related to the at least one financial simulation.

9. The non-transitory computer readable medium of claim 8, wherein the at least one financial simulation includes determining an impact of at least one action comprising: being denied for a credit product while sustaining a hard credit inquiry, getting a new credit card, getting a new personal loan, making a change in credit card balance or utilization, resolving a negative mark such as a collection, or taking on a new delinquency.

10. The non-transitory computer readable medium of claim 8, wherein the prediction determines both a direction and a magnitude of the user's credit score change under the at least one action.

11. The non-transitory computer readable medium of claim 8, wherein the aggregating includes creating a feature array that is submitted to the ML model.

12. The non-transitory computer readable medium of claim 8, wherein the prediction includes a trajectory of a financial condition of the user over a predetermined time period.

13. The non-transitory computer readable medium of claim 12, wherein the predetermined time period is six months.

14. The non-transitory computer readable medium of claim 12, wherein the predetermined time period is calculated by a difference between a first credit data pull date and a second credit data pull date of the user.

15. A system comprising:
a memory device;
a processor, coupled to the memory device, wherein the processor is configured to:
receive a request to perform at least one financial simulation of a financial profile pertaining to a consumer, wherein the request includes metadata that is required to perform the at least one financial simulation;
receive a credit data of the consumer, wherein the credit data includes at least one of a credit score, tradeline, credit inquiry, or a public record of the consumer;
aggregate the credit data of the consumer to determine one or more features required by the ML model;
submit the aggregated data to a Machine Learning (ML) model, wherein the ML model was trained using credit profiles of a plurality of consumers; and
generate a prediction related to the at least one financial simulation.

16. The system of claim 15, wherein the at least one financial simulation includes determining an impact of at least one action comprising: being denied for a credit product while sustaining a hard credit inquiry, getting a new credit card, getting a new personal loan, making a change in credit card balance or utilization, resolving a negative mark such as a collection, or taking on a new delinquency.

17. The system of claim 15, wherein the prediction determines both a direction and a magnitude of the user's credit score change under the at least one action.

18. The system of claim 15, wherein the aggregate includes creating a feature array that is submitted to the ML model.

19. The system of claim 15, wherein the prediction includes a trajectory of a financial condition of the user over a predetermined time period, wherein the predetermined time period is calculated by a difference between a first credit data pull date and a second credit data pull date of the user.

20. The system of claim 19, wherein the predetermined time period is six months.
